(19) United States
(12) Patent Application Publication
(10) Pub. No.: US 2026/0204701 A1
(43) Pub. Date: Jul. 16, 2026

(54) HOUSING ASSEMBLY OF BATTERY AND BATTERY

(71) Applicant: ZHUHAI COSMX BATTERY CO., LTD., Zhuhai (CN)

(72) Inventors: Xilong Li, Zhuhai (CN); Xin Lai, Zhuhai (CN); Zhida Wei, Zhuhai (CN); Jichun Xie, Zhuhai (CN)

(21) Appl. No.: 19/136,281

(22) PCT Filed: Mar. 20, 2024
(86) PCT No.: PCT/CN2024/082577

§ 371 Date: Jun. 5, 2025

(30) Foreign Application Priority Data
May 17, 2023 (CN) 202321203812.7
May 17, 2023 (CN) 202321203830.5

(51) Int. Cl. H01M 50/169; H01M 50/103; H01M 50/15; H01M 50/186

(52) U.S. Cl. CPC H01M 50/169; H01M 50/103; H01M 50/15; H01M 50/186

(57) ABSTRACT

The present application provides a housing assembly (1) of a battery (100) and a battery (100). The housing assembly includes: a top cover (11) and a bottom housing (12), where the bottom housing (12) and the top cover (11) jointly define a battery cell accommodating cavity (13); the top cover (11) has a first connecting edge (111) surrounding the battery cell accommodating cavity (13), and the bottom housing (12) has a second connecting edge (121) surrounding the battery cell accommodating cavity (13); the first connecting edge (111) is connected to the second connecting edge (121); the top cover (11) and the bottom housing (12) jointly form a housing body; connecting portions of the first connecting edge (111) and the second connecting edge (121) form a connecting sealing edge (16); the housing body includes a first weld (161) located at an end of the connecting sealing edge (16) away from the battery cell accommodating cavity (13); and an included angle between an outer side surface of the first weld (161) and a plane where the first connecting edge (111) and/or the second connecting edge (121) are/is located ranges from 60° to 150°. According to the housing assembly of a battery of the present application, a space occupied by a sealing edge is reduced while the structural strength of the housing assembly is ensured, thereby increasing the energy density of the battery.

The present application claims the priority to Chinese Patent Application No. 202321203830.5, filed with the China National Intellectual Property Administration on May 17, 2023, and Chinese Patent Application No. 202321203812.7, filed with the China National Intellectual Property Administration on May 17, 2023, which are hereby incorporated by reference in their entireties.

### TECHNICAL FIELD

The present application relates to the technical field of energy storage, and in particular to a housing assembly of a battery and a battery.

### BACKGROUND ART

In modern society, electrochemical devices represented by batteries are widely used. For example, lithium ion batteries, which have advantages such as large capacity, small size, light weight, and environmental friendliness, are widely used in digital electronic products, electric vehicles, and other industries.

However, with the development of science and technology, as the functions of electronic devices are continuously improved, power consumption is gradually increasing, and the requirements for battery energy density and other performances are also becoming higher and higher. Therefore, there is an urgent need to increase the energy density and improve other performances of a battery.

### SUMMARY

The present application provides a housing assembly of a battery and a battery. By cutting a place where a top cover and a bottom housing are welded in order to form a connecting sealing edge, the space occupied by the sealing edge can be reduced on the premise of ensuring the structural strength of the housing assembly, thereby facilitating an increase in the energy density of the battery.

In a first aspect, the present application provides a housing assembly of a battery, the housing assembly including: a top cover and a bottom housing, where the bottom housing and the top cover jointly define a battery cell accommodating cavity; the top cover has a first connecting edge surrounding the battery cell accommodating cavity, and the bottom housing has a second connecting edge surrounding the battery cell accommodating cavity; the first connecting edge is connected to the second connecting edge; the top cover and the bottom housing jointly form a housing body; connecting portions of the first connecting edge and the second connecting edge form a connecting sealing edge; the housing body includes a first weld located at an end of the connecting sealing edge away from the battery cell accommodating cavity; and an included angle between an outer side surface of the first weld and a plane where the first connecting edge and/or the second connecting edge are/is located ranges from 60° to 150°.

According to the housing assembly of a battery of the present application, by cutting a place where the top cover and the bottom housing are welded in order to form a connecting sealing edge, the space occupied by the sealing edge can be reduced on the premise of ensuring the structural strength of the housing assembly, thereby facilitating an increase in the energy density of the battery.

According to some embodiments of the present application, the outer side surface of the first weld is perpendicular to the plane where the first connecting edge and/or the second connecting edge are/is located.

Optionally, the first weld has a V-shaped or inverted V-shaped cross section.

Optionally, the first weld is arranged circumferentially around the battery cell accommodating cavity.

Optionally, a side surface of the first connecting edge facing the second connecting edge is a first joint surface, and a side surface of the second connecting edge facing the first connecting edge is a second joint surface, a width c of a gap between the first joint surface and the second joint surface adjacent to the first weld being in a range of c<20 μm.

Optionally, the first weld has a weld width ratio of a/b≥0.5, where a is an effective weld width of the first weld, and b is a total weld width of the first weld.

Optionally, the first connecting edge and the second connecting edge form the first weld by means of fusion welding.

Optionally, the first weld includes a plurality of sub-welds, the plurality of sub-welds at least partially overlapping each other to form a common fusion zone.

Optionally, a ratio of an area S1 of a weld pool zone corresponding to the first weld to an area S2 of the common fusion zone satisfies: S1/S2<10.

Optionally, the ratio of the area S1 of the weld pool zone corresponding to the first weld to the area S2 of the common fusion zone satisfies: 0<S1/S2<5.

In some embodiments, in the plurality of sub-welds, a width of the sub-weld located at an inner side is less than a width of the sub-weld located at an outer side.

In some embodiments, in the plurality of sub-welds, a width of the sub-weld located at an inner side is greater than a width of the sub-weld located at an outer side.

According to some embodiments of the present application, a weld pool zone corresponding to the first weld extends through the first connecting edge and the second connecting edge in a thickness direction of the housing assembly.

Optionally, an area of a weld mark of the first weld on the first connecting edge is a first weld mark area, and an area of a weld mark of the first weld on the second connecting edge is a second weld mark area, the first weld mark area being not equal to the second weld mark area, and a smaller one of the first weld mark area and the second weld mark area not exceeding 90% of a larger one of the first weld mark area and the second weld mark area.

Optionally, the first weld has a weld pool focus, and a position of the weld pool focus in a thickness direction of the first weld is within 110% of the sum of thicknesses of the first connecting edge and the second connecting edge.

Optionally, the first weld includes a first weld protrusion protruding from an upper surface of the first connecting edge, and a second weld protrusion protruding from a lower surface of the second connecting edge, and the weld pool focus is located on one of a joint surface between the first connecting edge and the second connecting edge, the first connecting edge, the second connecting edge, the first weld protrusion, and the second weld protrusion.

In a second aspect, the present application provides a battery, including: a housing assembly in the first aspect described above; and a battery cell arranged in the battery cell accommodating cavity.

According to the battery of the present application, by providing the housing assembly in the first aspect, it is possible to reduce the space occupied by a sealing edge on the premise of ensuring the structural strength of the housing assembly, thereby facilitating an increase in the energy density of the battery.

### BRIEF DESCRIPTION OF THE DRAWINGS

In order to illustrate the technical solutions in embodiments of the present application or in the prior art more clearly, the accompanying drawings required for describing the embodiments or the prior art will be briefly introduced below. Apparently, the drawings in the following description merely show some of the embodiments of the present application, and those of ordinary skill in the art would have obtained other drawings from these drawings without involving any inventive effort. In the figures:

FIG. 1 is a schematic structural diagram of a battery according to an embodiment of the present application;

FIG. 2 is a schematic structural diagram of a primary sealing edge of a housing assembly according to an embodiment of the present application;

FIG. 3 is a schematic structural diagram of a connecting sealing edge according to an embodiment of the present application;

FIG. 4 is a schematic diagram showing cutting for a housing assembly according to an embodiment of the present application;

FIG. 5 is a schematic structural diagram of a first weld of a housing assembly according to an embodiment of the present application;

FIG. 6 is a schematic cross-sectional view of encircled part A in FIG. 3 according to an embodiment;

FIG. 7 is a schematic cross-sectional view of encircled part A in FIG. 3 according to another embodiment;

FIG. 8 is a schematic cross-sectional view of encircled part A in FIG. 3 according to yet another embodiment;

FIG. 9 is a metallographic schematic diagram of a primary sealing edge shown in FIG. 3; and

FIG. 10 is a metallographic diagram of a first weld according to an embodiment of the present application.

### LIST OF REFERENCE SIGNS

100. Battery;
1. Housing assembly; 11. Top cover; 111. First connecting edge; 112. First joint surface; 12. Bottom housing; 121. Second connecting edge; 122. R-corner; 123. Second joint surface; 13. Battery cell accommodating cavity; 15. Primary sealing edge; 151. Primary weld; 1511. Primary sub-weld; 16. Connecting sealing edge; 161. First weld; 17. Weld pool zone; 171. Common fusion zone; 172. Fusion zone; 173. Non-fusion zone; 174. Heat-affected zone; 2. Battery cell;
L1. Center line; L2. Cutting line.

### DETAILED DESCRIPTION OF EMBODIMENTS

Embodiments of the present application will be described in detail below. Examples of the embodiments are shown in the accompanying drawings, and throughout the drawings, the same or similar reference signs refer to the same or similar elements or elements having the same or similar functions. The embodiments with reference to accompanying drawings described below are exemplary and are merely for explaining the present application, and should not be construed as limiting the present application.

In modern society, electrochemical devices represented by batteries are widely used. For example, lithium ion batteries, which have advantages such as large capacity, small size, light weight, and environmental friendliness, are widely used in digital electronic products, electric vehicles, and other industries.

However, with the development of science and technology, as the functions of electronic devices are continuously improved, power consumption is gradually increasing, and the requirements for battery energy density and other performances are also becoming higher and higher. Therefore, there is an urgent need to increase the energy density and improve other performances of a battery.

In view of this, the embodiments of the present application provide a housing assembly of a battery and a battery. By cutting a place where a top cover and a bottom housing are welded in order to form a connecting sealing edge, a space occupied by the sealing edge structure can be reduced on the premise of ensuring the structural strength of the cut housing assembly, thereby facilitating an increase in the energy density of the battery.

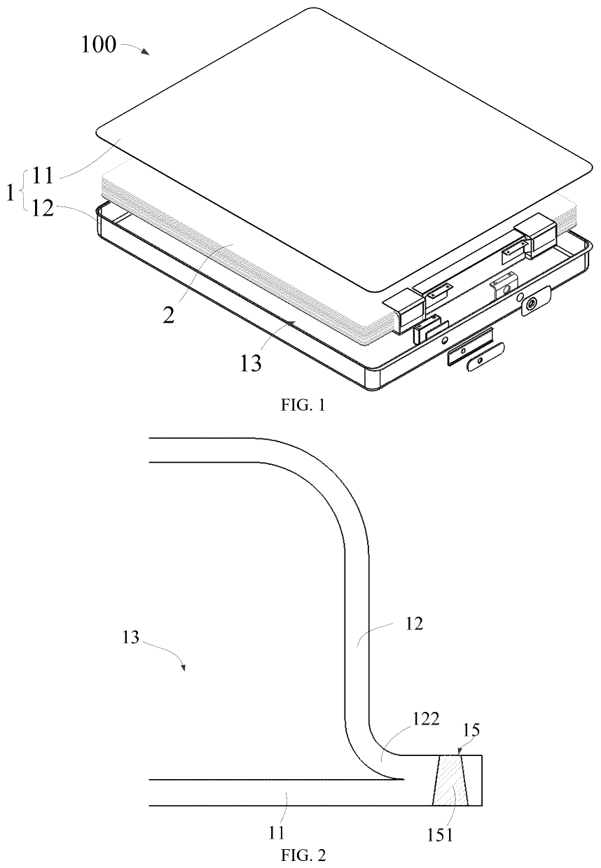

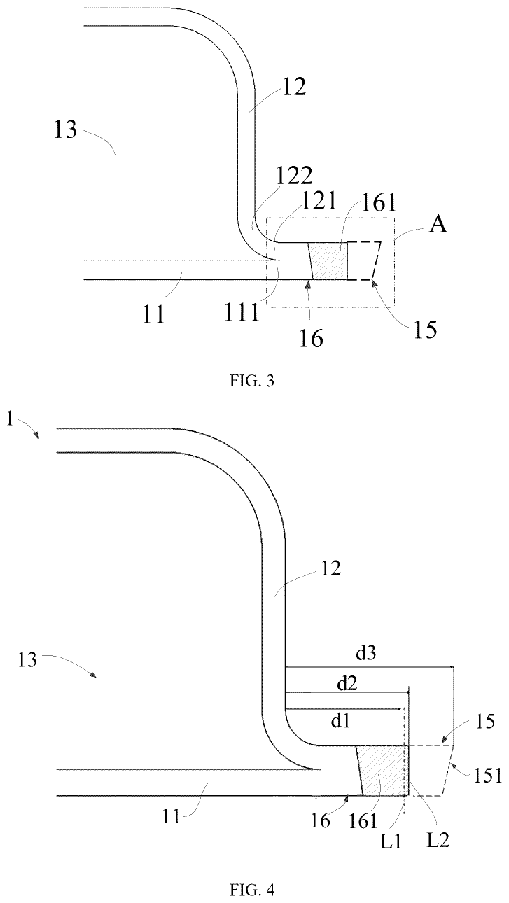

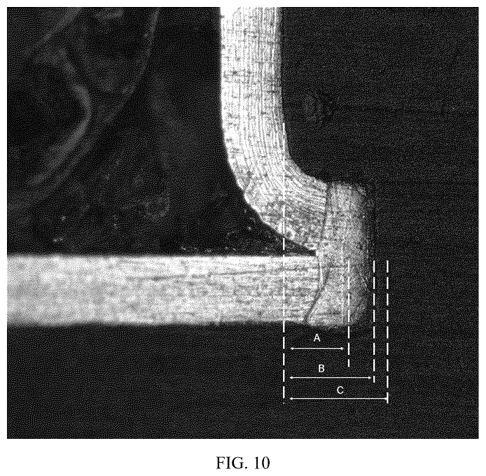

A battery 100 according to an embodiment of the present application is described in detail below with reference to FIGS. 1-10.

With reference to FIGS. 1-5, a housing assembly 1 of the battery 100 according to the embodiment of the present application may include: a top cover 11 and a bottom housing 12.

Specifically, the bottom housing 12 and the top cover 11 can jointly define a battery cell accommodating cavity 13 to dispose a battery cell 2. The top cover 11 has a first connecting edge 111 surrounding the battery cell accommodating cavity 13, and the bottom housing 12 has a second connecting edge 121 surrounding the battery cell accommodating cavity 13. The first connecting edge 111 is connected to the second connecting edge 121 to form a housing body, and connecting portions of the first connecting edge 111 and the second connecting edge 121 form a connecting sealing edge 16.

For example, the bottom housing 12 and the top cover 11 may each be configured to have a recess and a connecting flanged edge at the periphery of the recess, and when the bottom housing 12 and the top cover 11 are stacked and connected to each other, the recess in the top cover 11 and the recess in the bottom housing 12 jointly form the battery cell accommodating cavity 13 for accommodating the battery cell 2. In this case, the connecting flanged edge of the top cover 11 forms the first connecting edge 111, the connecting flanged edge of the bottom housing 12 forms the second connecting edge 121, and the connecting sealing edge 16 is located between two ends of the battery cell accommodating cavity 13 in a thickness direction. Alternatively, one of the bottom housing 12 and the top cover 11 is in the shape of a flat plate, and the other has a recess and a connecting flanged edge at the periphery of the recess.

Generally, the top cover 11 is in the shape of a flat plate, and the bottom housing 12 has a recess and a connecting flanged edge at the periphery of the recess. After the top cover 11 and the bottom housing 12 are stacked and connected to each other, the top cover 11 and the recess of the bottom housing 12 jointly form the battery cell accommodating cavity 13 for accommodating the battery cell 2. In this case, an edge portion of the top cover 11 beyond the battery cell accommodating cavity 13 forms the first connecting edge 111, the connecting flanged edge of the bottom housing 12 forms the second connecting edge 121, and the connecting sealing edge 16 is located at one end of the battery cell accommodating cavity 13 in the thickness direction.

The connecting sealing edge 16 has a first weld 161 at an end away from the battery cell accommodating cavity 13, that is, the first connecting edge 111 is connected to the second connecting edge 121 by welding. When welding is required, the bottom housing 12 and the top cover 11 are first pressed tightly together, followed by welding. Moreover, an included angle between an outer side surface of the first weld 161 (i.e., an end surface of the first weld 161 at an end away from the housing body) and a plane where the first connecting edge 111 and/or the second connecting edge 121 are/is located ranges from 60° to 150°.

In other words, the outer side surface of the first weld 161 is formed as a flat surface.

For example, the included angle between the outer side surface of the first weld 161 and the plane where the first connecting edge 111 and/or the second connecting edge 121 are/is located may be 60°, 80°, 90°, 100°, 110°, 120°, 130°or 150°. Of course, the included angle between the outer side surface of the first weld 161 and the plane where the first connecting edge 111 and/or the second connecting edge 121 are/is located may be rationally selected within the above range.

It should be noted that when different metal parts are connected by using welding processes, metal materials, once heated to a molten state, usually do not have a fixed shape, causing a non-flat side surface of the weld formed after solidification. Therefore, in this embodiment, the outer side surface of the first weld 161 is formed as a flat surface, and the first weld 161 is essentially formed by primary welding of the first connecting edge 111 and the second connecting edge 121, and then cutting a primary weld 151 (i.e., a welding portion during the primary welding of the first connecting edge 111 and the second connecting edge 121) formed by the primary welding, the first weld 161 is the remaining part after the primary weld 151 is cut, and the cut surface is the outer side surface of the first weld 161.

For example, the first connecting edge 111 of the top cover 11 and the second connecting edge 121 of the bottom housing 12 are first welded to each other to form a primary sealing edge 15 and the primary weld 151 on the primary sealing edge 15, and then the primary sealing edge 15 is cut along a cutting line L2 to form the connecting sealing edge 16 and the first weld 161 on the connecting sealing edge 16. The cutting line L2 may pass through the primary weld 151, the cutting line L2 may be inclined relative to the first connecting edge 111 and/or the second connecting edge 121, or may be perpendicular to the first connecting edge 111 and/or the second connecting edge 121. The resulting connecting sealing edge 16 serves as the actual sealing edge of a finished battery 100, such that the space at a sealing edge area can be fully utilized to achieve high structural strength and good sealing.

It will be appreciated that when only partial areas of the first connecting edge 111 and the second connecting edge 121 in a width direction are welded, the area corresponding to the primary weld 151 is only a partial area of the primary sealing edge 15; and when all areas of the first connecting edge 111 and the second connecting edge 121 in the width direction are welded, the area covered by the primary weld 151 is the entire area of the primary sealing edge 15, and the primary weld 151 surrounds the battery cell accommodating cavity 13.

In a housing assembly 1 of the battery 100 according to the embodiment of the present application, by cutting a place where the top cover 11 and the bottom housing 12 are welded in order to form a connecting sealing edge 16, the space occupied by a sealing edge structure can be reduced on the premise of ensuring the structural strength of the cut housing assembly 1, thereby facilitating an increase in the energy density of the battery 100.

Optionally, with reference to FIG. 4, the cutting line L2 is located at a side of a center line L1 of the primary weld 151 in the width direction that is away from the battery cell accommodating cavity 13, that is, the cutting line during cutting is located at the side of the center line L1 of the primary weld 151 away from the battery cell accommodating cavity 13. In this way, the width of the first weld 161 is ensured, that is, at least half of the structure of the primary weld 151 remains on the connecting sealing edge 16, such that on the premise of ensuring the strength of connection between the top cover 11 and the bottom housing 12, the space occupied by the sealing edge of the housing can be reduced to a certain extent, thereby increasing the energy density of the battery 100.

Optionally, the outer side surface of the first weld 161 is perpendicular to the plane where the first connecting edge 111 and/or the second connecting edge 121 are/is located, that is, when cutting the primary weld 151, the cutting line is perpendicular to the first connecting edge 111 and/or the second connecting edge 121. In this way, compared with the cut surface being inclined, the cutting difficulty and cost can be reduced, the cutting efficiency can be improved, and the cutting quality can be more easily controlled. In addition, an outer end surface of the connecting sealing edge 16 is relatively flat, making it easier to be mounted to a power consuming apparatus.

Optionally, the first weld 161 surrounds the battery cell accommodating cavity 13, such that the sealing for the battery cell accommodating cavity 13 can be ensured.

As an alternative embodiment, with reference to FIGS. 1-5, the top cover 11 is in the shape of a flat plate, and the bottom housing 12 has a recess and a connecting flanged edge at the periphery of the recess. After the top cover 11 and the bottom housing 12 are stacked and connected to each other, the top cover 11 and the recess of the bottom housing 12 jointly form the battery cell accommodating cavity 13 for accommodating the battery cell 2. An edge portion of the top cover 11 beyond the battery cell accommodating cavity 13 forms the first connecting edge 111, the connecting flanged edge of the bottom housing 12 forms the second connecting edge 121, there is an R-corner 122 between the second connecting edge 121 and a side wall of the recess, and the primary weld 151 is located at a side of the R-corner 122 away from the battery cell accommodating cavity 13.

According to some embodiments of the present application, the first weld 161 is formed by cutting the primary weld 151 along the cutting line L2 on at least one side of the battery cell accommodating cavity 13 in a circumferential direction. In an example of the battery 100 being square, the primary sealing edge 15 of the battery 100 includes a left sub-sealing edge, a rear sub-sealing edge, a right sub-sealing edge and a front sub-sealing edge which are sequentially connected in a clockwise direction, and when cutting, any one, two, three or all of the four sub-sealing edges, namely, the left sub-sealing edge, the rear sub-sealing edge, the right sub-sealing edge and the front sub-sealing edge, can be cut, thereby reducing the space occupied by the structure of the sealing edge of the housing assembly 1 in a corresponding direction as required to increase the energy density of the battery 100.

Optionally, the first weld 161 includes a first weld protrusion (not shown) protruding from an upper surface of the first connecting edge 111, and/or the first weld 161 includes a second weld protrusion (not shown) protruding from a lower surface of the second connecting edge 121, both the first weld protrusion and the second weld protrusion being in a bulged shape. In other words, a weld pool formed by welding the first connecting edge 111 and the second connecting edge 121, after solidification, may form only an upper protrusion on the upper surface of the first connecting edge 111 or only a lower protrusion on the lower surface of the second connecting edge 121, or the upper surface of the first connecting edge 111 and the lower surface of the second connecting edge 121 may have an upper protrusion and a lower protrusion, respectively, which can ensure that a melted portion between the first connecting edge 111 and the second connecting edge 121 has a relatively large volume, such that improvement of the structural strength of the first weld 161 is facilitated, thereby ensuring the overall structural strength and sealing performance of the housing assembly 1.

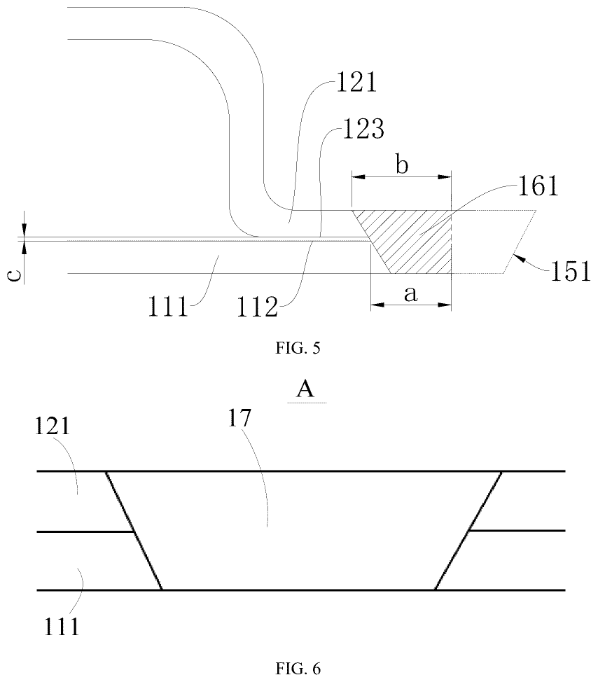

Optionally, with reference to FIG. 5, a side surface of the first connecting edge 111 facing the second connecting edge 121 is a first joint surface, and a side surface of the second connecting edge 121 facing the first connecting edge 111 is a second joint surface, a width c of a gap between the first joint surface and the second joint surface adjacent to the first weld 161 being in a range of: c<20 μm. In other words, in the case that only partial areas of the first connecting edge 111 and the second connecting edge 121 are welded, the first joint surface 112 and the second joint surface 123 are not microscopically completely fitted with each other, and the width c of the gap between portions of the first joint surface and the second joint surface at a side of the first weld 161 facing the battery cell accommodating cavity 13 and adjacent to the first weld 161 in the thickness direction of the housing assembly 1 is in a range of c<20 μm. For example, c may be 1 μm, 5 μm, 10 μm, 15 μm or 19 μm. Of course, the value of c may be rationally selected within the above range. In this way, the uniformity of a transition zone of a weld pool matrix can be ensured, reducing a weakened area during welding.

Optionally, with reference to FIG. 5, the first weld 161 has a weld width ratio of a/b≥0.5, where a is an effective weld width of the first weld 161, and b is a total weld width of the first weld 161. Here, the effective weld width refers to a weld width at a height corresponding to the first joint surface 112 and the second joint surface 123 in the thickness direction of the first weld 161, and the total weld width refers to a larger one of a width of a weld mark on the first connecting edge 111 and a width of a weld mark on the second connecting edge 121. For example, the value of a/b may be 0.5, 0.6, 0.7, 0.8 or more, and the value of a/b may be rationally selected according to actual needs. When welding on the basis of the above value, the structural strength of the first weld 161 formed after cutting can be ensured, so as to ensure the structural strength and sealing performance of connection of the cut connecting sealing edge 16.

Optionally, with reference to FIG. 4, a spacing d1 between the center line L1 of the primary weld 151 and a side wall of the housing assembly 1, a spacing d2 between the cutting line L2 and the side wall of the housing assembly 1, and a spacing d3 between an outer end surface of the primary weld 151 and the side wall of the housing assembly 1 satisfy: d1<d2<d3. In this way, it can be ensured that the cutting line L2 is located at the side of the center line L1 of the primary weld 151 away from the battery cell accommodating cavity 13, and partial structure of the primary sealing edge 15 is cut off, such that the energy density of the battery 100 can be improved on the premise of ensuring the connection strength and sealing performance of connection of the housing assembly 1.

Optionally, the first connecting edge 111 and the second connecting edge 121 form the first weld 161 by means of fusion welding. For example, the first connecting edge 111 and the second connecting edge 121 form the primary weld 151 by means of laser welding, and then the first weld 161 is formed by cutting. In this way, the quality of joint between two base metals is good, and the weld after welding has high structural strength and better sealing performance. It will be appreciated that when the first connecting edge 111 and the second connecting edge 121 are welded by means of laser welding, a weld mark on the upper surface of the first connecting edge 111 has a different width from a weld mark on the lower surface of the second connecting edge 121. For example, when welding from the first connecting edge 111 side, the width of the weld mark on the upper surface of the first connecting edge 111 is greater than the width of the weld mark on the lower surface of the second connecting edge 121, and in this case, the first weld 161 has an approximately inverted trapezoidal or inverted V-shaped cross section; and when welding from the second connecting edge 121 side, the width of the weld mark on the upper surface of the first connecting edge 111 is less than the width of the weld mark on the lower surface of the second connecting edge 121, and in this case, the first weld 161 has an approximately trapezoidal or V-shaped cross section.

Optionally, with reference to FIGS. 5-7, the primary weld 151 may include one or more primary sub-welds 1511. Accordingly, the first weld includes one or more sub-welds, each of the sub-welds being the remaining part of the corresponding primary sub-weld 1511 after cutting.

It will be appreciated that each of the primary sub-welds 1511 corresponds to performing the welding process once, that is, when the primary weld 151 includes a plurality of primary sub-welds 1511, the primary weld 151 is formed by performing the welding process a plurality of times on the first connecting edge 111 and the second connecting edge 121, and when the primary weld 151 includes only one primary sub-weld 1511, i.e., the primary weld 151 itself, the primary weld 151 is formed by performing the welding process once on the first connecting edge 111 and the second connecting edge 121. It will be appreciated that when the primary weld 151 includes only one primary sub-weld 1511, it is realized by means of a laser welding system with a relatively large spot, and when the primary weld 151 includes a plurality of primary sub-welds 1511, it is realized by means of a laser welding system with a relatively small spot.

When the primary weld 151 includes only one primary sub-weld 1511, the cutting line L2 is located at the side of the center line L1 of the primary sub-weld 1511 in the width direction that is away from the battery cell accommodating cavity 13. When the primary weld 151 includes a plurality of primary sub-welds 1511, the plurality of primary sub-welds 1511 at least partially overlap each other to form a common fusion zone 171, and the cutting line L2 is located at a side of the center line L1 of the common fusion zone 171 in the width direction that is away from the battery cell accommodating cavity 13. By providing a plurality of primary sub-welds 1511, compared with only one primary sub-weld 1511, the structural strength of the primary weld 151 can be further enhanced, and the reliability of connection between the first connecting edge 111 and the second connecting edge 121 can be improved, and the cutting line L2 is located at the side of the center line L1 of the common fusion zone 171 in the width direction that is away from the battery cell accommodating cavity 13, such that the width of the common fusion zone 171 on the first weld 161 formed after cutting can be ensured, thereby improving the reliability of the finished battery 100.

It can be appreciated that with reference to FIG. 10, when the first weld 161 has a plurality of sub-welds, a first one of the sub-welds may be formed by offsetting a distance A outward from the connection between the R-corner 122 and the side wall of the recess of the bottom housing 12, and a second one of the sub-welds is further formed by offsetting a distance A+B outward from the connection as a reference. Similarly, in this way, several sub-welds are formed as needed.

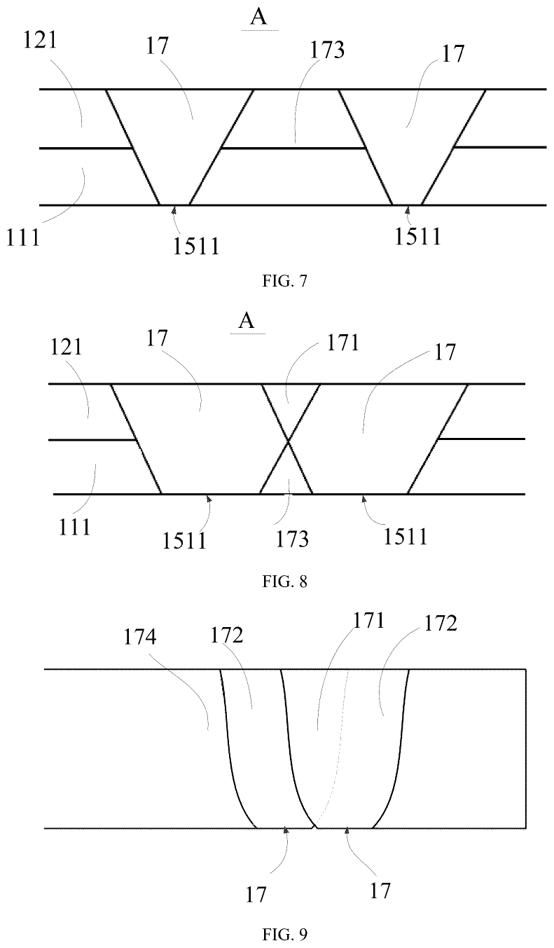

It will be appreciated that with reference to FIGS. 7 and 8, the areas of the plurality of sub-welds that do not overlap other sub-welds are fusion zones 172, and a base metal area outside the fusion zone 172 further includes a heat-affected zone 174, a non-fusion zone 173, etc. Adjusting the proportion range of different areas such as the non-fusion zone 173, the fusion zone 172, and the common fusion zone 171 on the sealing edge as needed can flexibly meet different requirements for welding tensile and sealing performance. Of course, in some other embodiments, if any two of the plurality of sub-welds do not overlap each other, an area between any two adjacent sub-welds is a non-fusion zone 173.

In a specific example, a ratio of an area S1 of a weld pool zone 17 corresponding to the first weld 161 to an area S2 of the common fusion zone 171 satisfies: S1/S2<10, for example, a value of S1/S2 may be 1, 2, 3, 5, 7 or 9. Further, the ratio of the area S1 of the weld pool zone 17 corresponding to the first weld 161 to the area S2 of the common fusion zone 171 satisfies: 0<S1/S2<5. In this range, increasing the proportion of the common fusion zone can effectively enhance the welding strength and sealing performance of the first weld 161 formed by a plurality of sub-welds. Here, the weld pool zone 17 refers to an area where the base metal corresponding to the first weld 161 is heated and melted into a pool-like shape, i.e., an area where the first weld 161 is located in a molten state.

According to some embodiments of the present application, with reference to FIGS. 5-7, the weld pool zone 17 corresponding to the first weld 161 extends through the first connecting edge 111 and the second connecting edge 121 in the thickness direction of the housing assembly 1, that is, when the first connecting edge 111 and the second connecting edge 121 are welded to each other, the resulting weld pool extends completely through the first connecting edge 111 and the second connecting edge 121, such that the first weld 161 also extends completely through the first connecting edge 111 and the second connecting edge 121. In this way, a molten liquid formed by melting the first connecting edge 111 and a molten liquid formed by melting the second connecting edge 121 can merge into one, ensuring the quality of welding between the first connecting edge 111 and the second connecting edge 121, and improving the structural strength of the housing assembly 1. In this way, even if cutting is performed, the structural strength of the cut connecting sealing edge 16 can be improved.

Optionally, an area of a weld mark of the first weld 161 on the first connecting edge 111 is a first weld mark area, and an area of a weld mark of the first weld 161 on the second connecting edge 121 is a second weld mark area. The first weld mark area is not equal to the second weld mark area, and a smaller one of the first weld mark area and the second weld mark area does not exceed 90% of a larger one of the first weld mark area and the second weld mark area. For example, when the first connecting edge 111 and the second connecting edge 121 are connected to each other by means of laser welding, if welding is performed from the first connecting edge 111 side, the first weld mark area is larger than the second weld mark area, and in this case, the second weld mark area does not exceed 90% of the first weld mark area. For example, the second weld mark area may be 0 or 10%, 20%, 50%, 70% or 90% of the first weld mark area, where when the second weld mark area is 0, the first weld 161 does not pass through the second connecting edge 121; and if welding is performed from the second connecting edge 121 side, the second weld mark area is larger than the first weld mark area, and in this case, the first weld mark area does not exceed 90% of the second weld mark area. For example, the first weld mark area may be 0, or 10%, 20%, 50%, 70%, or 90% of the second weld mark area, where when the first weld mark area is 0, the first weld 161 does not pass through the first connecting edge 111. The first connecting edge 111 and the second connecting edge 121 are connected to each other by means of laser welding, so that a better effect of fusion between the first connecting edge 111 and the second connecting edge 121 is achieved, resulting in an improved welding quality.

In some embodiments, in the plurality of sub-welds, a subsequently formed sub-weld at least partially covers a previously formed sub-weld. For example, when welding from the outside to the inside in an inner-outer direction of the battery cell accommodating cavity 13, the sub-weld at an inner side at least partially covers the sub-weld at an outer side; and when welding from the inside to the outside in the inner-outer direction of the battery cell accommodating cavity chamber 13, the sub-weld at an outer side at least partially covers the inner sub-weld at an inner side. In this way, it can be ensured that there is a common fusion zone between two adjacent sub-welds, such that the plurality of sub-welds can enhance the structural strength at the primary weld 151, thereby ensuring the structural strength and sealing performance of the first weld 161 formed after cutting.

It will be appreciated that the weld mark widths of the plurality of sub-welds may be the same or different, and the weld mark width of each sub-weld may be rationally set according to actual needs, so as to meet the requirements for different aspects of performance, such as sealing performance and strength.

In some embodiments, in the plurality of sub-welds, the width of the sub-weld located at the inner side is less than the width of the sub-weld located at the outer side, such that the sealing performance of the battery cell accommodating cavity 13 is effectively improved.

Alternatively, in other embodiments, in the plurality of sub-welds, the width of the sub-weld located at the inner side is greater than the width of the sub-weld located at the outer side, such that the structural strength of the housing assembly 1 can be effectively improved.

Optionally, the weld pool corresponding to the first weld 161 has a weld pool focus, and the position of the weld pool focus in the thickness direction of the first weld 161 is within the height range corresponding to 110% of the sum of the thicknesses of the first connecting edge 111 and the second connecting edge 121. Here, in an example of the weld pool being in the shape of a mountain peak, the weld pool focus refers to a peak point, i.e., the highest point of the weld pool. For example, the weld pool focus may be located on the joint surface between the first connecting edge 111 and the second connecting edge 121, on the first connecting edge 111 of the top cover 11, on the second connecting edge 121 of the bottom housing 12, on the first weld protrusion of the first connecting edge 111 (i.e., at an outer side of the upper surface of the first connecting edge 111), or on the second weld protrusion of the second connecting edge 121 (i.e., at an outer side of the lower surface of the second connecting edge 121).

The housing assembly 1 of the battery 100 according to a specific embodiment of the present application is described below.

### Embodiment 1

With reference to FIGS. 1-5, the housing assembly 1 according to this embodiment includes: a top cover 11 and a bottom housing 12.

Specifically, the top cover 11 is in the shape of a flat plate, the bottom housing 12 has a recess and a connecting flanged edge at the periphery of the recess. After the top cover 11 and the bottom housing 12 are stacked and connected to each other, the top cover 11 and the recess of the bottom housing 12 jointly form a battery cell accommodating cavity 13 for accommodating a battery cell 2. In this case, an edge portion of the top cover 11 beyond the battery cell accommodating cavity 13 forms the first connecting edge 111, and the connecting flanged edge of the bottom housing 12 forms the second connecting edge 121. The first connecting edge 111 and the second connecting edge 121 are welded to each other to form a primary weld 151 surrounding the battery cell accommodating cavity 13, the primary weld 151 being formed by performing a fusion welding once for the first connecting edge 111 and the second connecting edge 121.

A side surface of the first connecting edge 111 facing the second connecting edge 121 is a first joint surface, and a side surface of the second connecting edge 121 facing the first connecting edge 111 is a second joint surface, a width c of a gap between the first joint surface and the second joint surface adjacent to the first weld 161 being 10 μm.

A primary sealing edge 15 is cut along a cutting line L2 to form a connecting sealing edge 16 and a first weld 161 on the connecting sealing edge 16, the cutting line L2 being located at a side of the center line L1 of the primary weld 151 in a width direction that is away from the battery cell accommodating cavity 13. The first weld 161 has a weld width ratio of a/b≥0.5, and an outer end surface of the first weld 161 is perpendicular to both the first connecting edge 111 and the second connecting edge 121. A spacing dl between the center line L1 of the primary weld 151 and a side wall of the housing assembly 1, a spacing d2 between the cutting line L2 and the side wall of the housing assembly 1, and a spacing d3 between an outer end surface of the primary weld 151 and the side wall of the housing assembly 1 satisfy: d1<d2<d3.

### Embodiment 2

With reference to FIGS. 1-4 and FIGS. 7 and 8, a housing assembly 1 of this embodiment includes: a top cover 11 and a bottom housing 12.

Specifically, the top cover 11 is in the shape of a flat plate, the bottom housing 12 has a recess and a connecting flanged edge at the periphery of the recess. After the top cover 11 and the bottom housing 12 are stacked and connected to each other, the top cover 11 and the recess of the bottom housing 12 jointly form a battery cell accommodating cavity 13 for accommodating a battery cell 2. In this case, an edge portion of the top cover 11 beyond the battery cell accommodating cavity 13 forms the first connecting edge 111, and the connecting flanged edge of the bottom housing 12 forms the second connecting edge 121. The first connecting edge 111 and the second connecting edge 121 are welded to each other to form a primary weld 151 surrounding the battery cell accommodating cavity 13.

A primary sealing edge 15 is cut along a cutting line L2 to form a connecting sealing edge 16 and a first weld 161 on the connecting sealing edge 16, the cutting line L2 being located at a side of the center line L1 of a common fusion zone 171 in the primary weld 151 in a width direction that is away from the battery cell accommodating cavity 13. The first weld 161 has a weld width ratio of a/b≥0.5, and an outer end surface of the first weld 161 is perpendicular to both the first connecting edge 111 and the second connecting edge 121. A spacing d1 between the center line L1 of the primary weld 151 and a side wall of the housing assembly 1, a spacing d2 between the cutting line L2 and the side wall of the housing assembly 1, and a spacing d3 between an outer end surface of the primary weld 151 and the side wall of the housing assembly 1 satisfy: d1<d2<d3.

The first weld 161 includes a plurality of sub-welds, each of the sub-welds being formed by performing a fusion welding once for the first connecting edge 111 and the second connecting edge 121. In the plurality of sub-welds, a subsequently formed sub-weld at least partially covers a previously formed sub-weld, such that the plurality of primary sub-welds at least partially overlap each other to form the common fusion zone 171. In the plurality of sub-welds, the width of the sub-weld located at the inner side is less than the width of the sub-weld located at the outer side.

The ratio of the area S1 of the weld pool zone 17 corresponding to the first weld 161 to the area S2 of the common fusion zone 171 satisfies: 0<S1/S2<5. The weld pool corresponding to the first weld 161 has a weld pool focus, and the position of the weld pool focus in the thickness direction of the first weld 161 is within 110% of the sum of the thicknesses of the first connecting edge 111 and the second connecting edge 121.

A side surface of the first connecting edge 111 facing the second connecting edge 121 is a first joint surface, and a side surface of the second connecting edge 121 facing the first connecting edge 111 is a second joint surface, a width c of a gap between the first joint surface and the second joint surface adjacent to the first weld 161 being 15 μm.

A battery 100 according to an embodiment in a second aspect of the present application is described below.

The battery 100 according to the embodiment of the present application includes: a housing assembly 1 in the above embodiment and a battery cell 2.

Specifically, the battery cell 2 is arranged in a battery cell accommodating cavity 13 of the housing assembly 1 described above.

In the battery 100 according to the embodiment of the present application, by providing the housing assembly 1 in the embodiment described above, it is possible to reduce the space occupied by a sealing edge on the premise of ensuring the structural strength of the housing assembly 1, thereby facilitating an increase in the energy density of the battery 100.

In the present application, unless expressly stated or limited otherwise, the terms such as “mounting”, “connecting”, “connection” and “fixing” should be interpreted broadly, for example, either fixed or detachable connection, or integration; may be a mechanical connection or an electrical connection, or may be a communication connection; may be a direct connection or an indirect connection by means of an intermediate medium, or may be internal communication between two elements or interaction between the two elements. For those of ordinary skill in the art, the specific meaning of the terms mentioned above in the present application should be construed according to specific circumstances.

In the description of the present description, the description of reference to terms such as “an embodiment”, “some embodiments”, “examples”, “specific examples”, or “some examples” means that specific features, structures, materials or characteristics described in combination with the embodiment(s) or example(s) are included in at least one embodiment or example of the present application. In the present description, the schematic expressions of the above terms do not necessarily refer to the same embodiment or example. Moreover, the specific features, structures, materials or characteristics described can be combined in any one or more embodiments or examples in any suitable manner. In addition, without any contradiction, a person skilled in the art may incorporate and combine different embodiments or examples and features of the different embodiments or examples described in the present description.

It should be finally noted that the above embodiments are merely used for illustrating rather than limiting the technical solutions of the present application. Although the present application has been illustrated in detail with reference to the foregoing embodiments, it should be understood by those of ordinary skill in the art that the technical solutions described in the foregoing embodiments may still be modified, or some or all of the technical features thereof may be equivalently substituted; and these modifications or substitutions do not make the essence of the corresponding technical solution depart from the scope of the technical solutions of the embodiments of the present application.

1. A housing assembly of a battery, comprising: a top cover and a bottom housing, wherein the top cover and the bottom housing jointly define a battery cell accommodating cavity, the top cover has a first connecting edge surrounding the battery cell accommodating cavity, and the bottom housing has a second connecting edge surrounding the battery cell accommodating cavity;
the first connecting edge is connected to the second connecting edge, the top cover and the bottom housing jointly form a housing body, connecting portions of the first connecting edge and the second connecting edge form a connecting sealing edge;
the housing body comprises a first weld located at an end of the connecting sealing edge away from the battery cell accommodating cavity; and
an included angle between an outer side surface of the first weld and a plane where the first connecting edge and/or the second connecting edge are/is located ranges from 60° to 150°.

2. The housing assembly of a battery according to claim 1, wherein the outer side surface of the first weld is perpendicular to the plane where the first connecting edge and/or the second connecting edge are/is located.

3. The housing assembly of a battery according to claim 1, wherein the first weld has a V-shaped or inverted V-shaped cross section.

4. The housing assembly of a battery according to claim 1, wherein the first weld is arranged circumferentially around the battery cell accommodating cavity.

5. The housing assembly of a battery according to claim 1, wherein a side surface of the first connecting edge facing the second connecting edge is a first joint surface, and a side surface of the second connecting edge facing the first connecting edge is a second joint surface, a width c of a gap between the first joint surface and the second joint surface adjacent to the first weld being in a range of c<20 μm.

6. The housing assembly of a battery according to claim 5, wherein the first weld has a weld width ratio of a/b≥0.5, wherein a is an effective weld width of the first weld, and b is a total weld width of the first weld.

7. The housing assembly of a battery according to claim 1, wherein the first connecting edge and the second connecting edge form the first weld by means of fusion welding.

8. The housing assembly of a battery according to claim 1, wherein the first weld comprises a plurality of sub-welds, and
the plurality of sub-welds at least partially overlap each other to form a common fusion zone.

9. The housing assembly of a battery according to claim 8, wherein a ratio of an area S1 of a weld pool zone corresponding to the first weld to an area S2 of the common fusion zone satisfies: S1/S2<10.

10. The housing assembly of a battery according to claim 9, wherein the ratio of the area S1 of the weld pool zone corresponding to the first weld to the area S2 of the common fusion zone satisfies: 0<S1/S2<5.

11. The housing assembly of a battery according to claim 8, wherein in the plurality of sub-welds, a width of the sub-weld located at an inner side is less than a width of the sub-weld located at an outer side.

12. The housing assembly of a battery according to claim 8, wherein in the plurality of sub-welds, a width of the sub-weld located at an inner side is greater than a width of the sub-weld located at an outer side.

13. The housing assembly of a battery according to claim 1, wherein a weld pool zone corresponding to the first weld extends through the first connecting edge and the second connecting edge in a thickness direction of the housing assembly.

14. The housing assembly of a battery according to claim 1, wherein an area of a weld mark of the first weld on the first connecting edge is a first weld mark area, and an area of a weld mark of the first weld on the second connecting edge is a second weld mark area, the first weld mark area being not equal to the second weld mark area, and a smaller one of the first weld mark area and the second weld mark area not exceeding 90% of a larger one of the first weld mark area and the second weld mark area.

15. The housing assembly of a battery according to claim 1, wherein the first weld has a weld pool focus, and a position of the weld pool focus in a thickness direction of the first weld is within 110% of the sum of thicknesses of the first connecting edge and the second connecting edge.

16. The housing assembly of a battery according to claim 15, wherein the first weld comprises a first weld protrusion protruding from an upper surface of the first connecting edge, and a second weld protrusion protruding from a lower surface of the second connecting edge, and
the weld pool focus is located on one of a joint surface between the first connecting edge and the second connecting edge, the first connecting edge, the second connecting edge, the first weld protrusion, and the second weld protrusion.

17. A battery, comprising:
a housing assembly of a battery according to claim 1; and
a battery cell arranged in the battery cell accommodating cavity.
